(19) United States
(12) Patent Application Publication
(10) Pub. No.: US 2002/0017090 A1
(43) Pub. Date: Feb. 14, 2002

(54) Harvesting apparatus

(76) Inventor: Leo Schulze Hockenbeck, Everswinkel (DE)

Correspondence Address: Kevin J. Moriarty, Patent Department, DEERE & COMPANY, One John Deere Place, Moline, IL, 61265-8098, US

(21) Appl. No.: 09/859,787

(22) Filed: May 17, 2001

(30) Foreign Application Priority Data
May 27, 2000 (DE) 100 26 500.6

(51) Int. Cl. A01D 80/00; A01B 63/22; A01B 63/32

(52) U.S. Cl. 56/16.2; 172/311; 172/456; 172/468; 56/385; 56/397

(57) ABSTRACT

An agricultural harvesting apparatus comprising a base frame, a pivotally mounted wing frame and a pivotally mounted outer wing frame. The outer wing frame is folded and unfolded into its operating and transport positions by an outer wing pivot drive. An outer wing pivot sensing hydraulic cylinder drives inner and outer pushing rods pivoting hydraulic cylinders and a pivot locking hydraulic cylinder so that the associated elements are placed in their respective transport or operating positions. After the outer wing frame is folded together with the associated elements into their transport positions a wing pivot hydraulic cylinder folds the wing frame.

### FIELD OF THE INVENTION

The present invention is directed to an agricultural harvesting apparatus having a base frame and an outer wing frame. The outer wing frame has a transport position wherein the outer wing frame is folded and an operating position wherein the outer wing frame is unfolded. Movement of the outer wing frame actuates an outer wing sensing hydraulic cylinder which in turn drives the folding and unfolding of other elements on the harvesting apparatus.

### BACKGROUND OF THE INVENTION

DE 3605933 A discloses a harvesting attachment for a harvesting machine comprising a base frame and two mowing and pick-up attachments that are mounted on the base frame such that they can be pivoted separately. When the harvesting attachment is moved from the operating position into the transport position in order to make it possible to drive the harvesting machine carrying the harvesting attachment on a roadway, hydraulic cylinders are successively actuated and the left and the right mowing and pick-up attachments are then successively moved into the transport position.

DE 4322263 A discloses a mowing apparatus for mowing crop residue. This mowing device contains two lateral mower bars that are transverse to the driving direction and can be pivoted into a transport position. The three mower bars are equipped with rotatable mowing blades. The pivoting of the outer mower bars is realized with the aid of a double-action hydraulic cylinder, where the central mower bar is displaced upward into the transport position by a hydraulic cylinder assigned thereto. The hydraulic cylinders of the mower bars are provided with additional stroke volume in order to enable the lateral mower bars to yield opposite to the driving direction. The additional stroke volume is hydraulically connected to an operating cylinder for raising the lateral mower bars. In case of an overload, oil is displaced from the additional displacement of the hydraulic cylinder to drive the operating cylinder.

### SUMMARY OF THE INVENTION

It is an object of the present invention to provide an agricultural harvesting apparatus wherein related elements are automatically folded and unfolded by the movement of an outer wing frame relative to the wing frame.

The invention comprises an agricultural harvesting apparatus with a first element that can be moved from a transport position into an operating position and/or vice versa by means of a suitable drive. The drive of the first element may be an electric motor, a hydraulic motor or cylinder, a manual assembly or by the drive motor of a harvesting machine that carries the harvesting apparatus via a suitable drive train. The first element (and the respective drive) is mechanically coupled to a first hydraulic cylinder such that the latter is driven by the drive and acts as a pump for the hydraulic fluid when the first element is moved. The hydraulic fluid displaced from the first hydraulic cylinder serves to drive hydraulically a second hydraulic cylinder that is coupled to and moves the second element of the harvesting apparatus from the transport position into the operating position or from the operating position into the transport position. However, it would also be conceivable for the second element to carry out one of these movements under the influence of a different drive or the second element may be moved manually and with the support of gravity.

This results in an agricultural harvesting apparatus, in which a second element is automatically moved into the transport position or into the operating position without requiring complicated controls for the second hydraulic cylinder. A hydraulic pump is no longer required for charging the second hydraulic cylinder with pressurized hydraulic fluid.

If the second hydraulic cylinder moves the second element from the transport position into the operating position and back into the transport position, it is advantageous to design the first and the second hydraulic cylinder in the form of double-acting cylinders. The two pressure chambers of the first and the second hydraulic cylinder are hydraulically connected (directly or indirectly) such that the hydraulic fluid is pumped back and forth between the two hydraulic cylinders when the drive of the first element is moved.

The invention also proposes to provide a third and preferably also a fourth element with corresponding third and fourth hydraulic cylinders, where said hydraulic cylinders are designed for moving the assigned element from the operating position into the transport position and vice versa. The hydraulic cylinders may be connected in parallel and directly supplied with hydraulic fluid by the first hydraulic cylinder. Alternatively, the hydraulic cylinders may practically be connected in series and acted upon indirectly by the first hydraulic cylinder, i.e., with other intervening hydraulic cylinders.

It is particularly advantageous to arrange the hydraulic cylinders in a closed hydraulic circuit so that neither a sump nor a pump is required for supplying the hydraulic fluid. Here, it is preferred to connect the respective piston rod pressure chambers and the piston surface pressure chambers of two cylinders to one another. In this way, identical strokes can be achieved with the same type of hydraulic cylinders. This solution is particularly advantageous in instances in which an even number of hydraulic cylinders must be actuated. If an odd number of hydraulic cylinders is provided, one hydraulic cylinder may “run idle,” i.e., one hydraulic cylinder does not move an element but produces the proportional change in the volume flow required for coupling the last hydraulic cylinder. In an alternative solution for an odd number of hydraulic cylinders, one (or more) hydraulic cylinders with a continuous piston rod that extends through both pressure chambers is/are used, as described in US 5,450,908 A. One pressure chamber of such a hydraulic cylinder always discharges the same quantity of hydraulic fluid as that being pumped into the other pressure chamber.

The invention is particularly suitable for a mowing attachment with intake and mowing devices. Mowing attachments of this type are usually realized in the form of an attachment for a combine-harvester or a field chopper. In one embodiment that is realized in the form of a corn harvester, they serve for harvesting the entire plant. In another embodiment, they serve as pickers for harvesting corn ears or other grain crops.

According to one preferred additional refinement of the invention, the first element of the harvesting apparatus comprises an outer wing frame carrying an intake and mowing device of the mowing attachment. The outer wing frame is pivoted relative to a wing frame to which it is pivotally attached from and into a transport position of an operating position. The first element is usually pivoted upward or backward by a hydraulic cylinder from the operating position, where it is oriented horizontally and transverse to the forward driving direction into the transport position.

The second and/or third element of the harvesting apparatus can be inner and outer pushing rods, which in the operating position, are arranged in front of and above the intake and mowing apparatus with respect to the forward driving direction. The inner and outer pushing rods are moved into and out of their transport or operating positions by second and third hydraulic cylinders that pivot the pushing rods forward or backward, and upward or downward.

The fourth element of the harvesting apparatus may consist of a locking device that, in the transport position, blocks the pivoting movement of the harvesting apparatus relative to the harvesting machine carrying the harvesting apparatus about a pivot bearing arrangement. The locking device releases the pivoting movement in the operating position.

### BRIEF DESCRIPTION OF THE DRAWINGS

FIG. 1, a schematic top view of a harvesting apparatus.

FIG. 2, a front view of the harvesting apparatus.

FIG. 3, a schematic representation of the hydraulic system of the harvesting apparatus.

### DETAILED DESCRIPTION

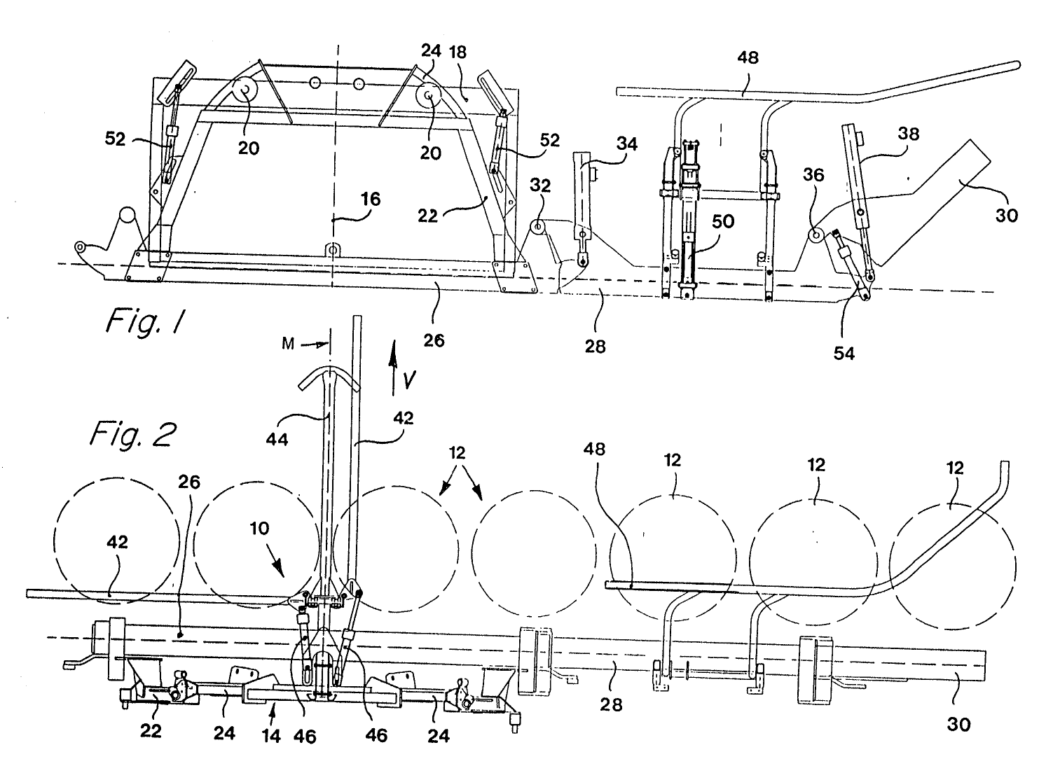

FIGS. 1 and 2 show an agricultural harvesting apparatus 10 in the form of a mowing attachment equipped with a total of ten intake and mowing devices 12. The intake and mowing devices 12 are symmetrically arranged relative to a vertical central plane M of the harvesting apparatus 10 and serve to draw in and cut off standing plants in a field. FIG. 2 shows that four intake and mowing devices are mounted to the base frame 26, that two right intake and mowing devices 12 are mounted to the right wing frame 28, and that one intake and mowing device 12 is mounted to the right outer wing frame 30. The plants that are drawn in and cut off are conventionally transported to a harvesting machine (not shown), which is behind harvesting apparatus 10.

The harvesting apparatus 10 is mounted to the harvesting machine by a pivot bearing arrangement 14 that allows the harvesting apparatus 10 to pivot relative to the harvesting machine about a horizontal axis 16 that extends in the vertical central plane M and parallel to the forward driving direction V. The axis 16 is approximately arranged at the elevation of the center of the intake of the transport channel of the harvesting machine. The pivot bearing arrangement 14 contains a gantry-shaped support frame 18 that is mounted on the harvesting machine. Two forwardly extending rollers 20 that can be turned about a horizontal axis are arranged on the upper side of this carrying frame. Pipe sections 24 that are arranged on the upper side of a pivot frame 22 lie on the rollers 20. The pivot frame 22 carries a base frame 26 that is oriented transverse to the forward driving direction V. Left and right wing frames 28 each carry two intake and mowing devices 12 and are pivotally mounted on the respective lateral ends of the base frame 26. Left and right outer wing frames 30 each hold one intake and mowing device 12 and are pivotally mounted on the respective wing frames 28. The pivot bearing arrangement 14 makes it possible for the relatively wide harvesting apparatus 10 to pivot about the axis 16 by an angle of approximately five degrees. During this process, the pipe sections 24 roll on the rollers 20. Active control of the pivoting movement about the axis 16 is not provided because the harvesting apparatus 10 usually remains oriented parallel to the ground during ground contact. For example, when the harvesting machine drives over a furrow in the ground, the harvesting apparatus 10 pivots about the axis 16 and maintains normal ground contact. Torque caused by ground contact on the intake housing and the feeder house of the harvesting machine is prevented. Dampers (not shown in the figures) may be arranged on the pivot bearing arrangement 14 in order to prevent undesirable oscillations.

In the operating position shown in FIG. 1, the harvesting apparatus 10 is relatively wide. In order to make it possible to transport the harvesting apparatus on a public road without having to remove the harvesting apparatus, the wing frames 28 are pivotally mounted to the base frame 26 about a horizontal wing pivot axis 32 that extends parallel to the forward driving direction V. Thus, the wing frames 28 can be pivoted approximately ninety degrees into the transport position by means of a wing pivot hydraulic cylinder 34. In the transport position, the wing frames are oriented vertically. The outer wing frames 30 are pivotally mounted to the wing frames 28 such that they can be pivoted about a horizontal outer wing pivot axis 36 that extends parallel to the forward driving direction V. The outer wing frames 30 can be pivoted approximately one hundred twenty degrees. Thus, the outer wing frames can be pivoted into a transport position, where they are arranged above the base frame 26 with an inward and downward incline. An outer wing pivot drive 38 in the form of an outer wing pivot hydraulic cylinder is provided for pivoting the outer wing frames 30. The control of the hydraulic cylinder 34 and the drive 38 is preferably realized in such a way that the outer wing frames 30 are initially pivoted from the operating position into the transport position by the outer wing pivot drive 38. The wing frames 28 are then raised by the wing pivot hydraulic cylinder 34. The lowering of the wing frames 28 and the outer wing frames 30 into the operating position takes place in the reverse sequence. A detailed description of the pivoting mechanism of the harvesting apparatus 10 is provided in EP 0,992,817 A.

The outer wing frames 30 will now be defined as a first element that is moved from an operating position into a transport position or vice versa. In addition to the first element 30, the harvesting apparatus 10 also contains a series of other elements that must be moved from the operating position into the transport position.

An inner pushing rod 42 is arranged on either side of a divider rod 44 that lies on the vertical central plane M. In FIG. 2, the left hand inner pushing rod 42 is shown in its operating position transverse to the forward driving direction V, and the right hand inner pushing rod 42 is pivoted forward into its transport position parallel to the forward driving direction V. In order to pivot the inner pushing rods 42, each is assigned an inner push rod hydraulic cylinder 46, one end of which is coupled to the pivot frame 22 and the other end of which is coupled to the respective inner pushing rod 42. The inner pushing rods 42 comprise a third element.

Outer pushing rods 48 that can be pivoted backward into a transport position about a horizontal axis that extends transverse to the forward driving direction V are mounted on the wing frames 28. This pivoting movement is realized with the aid of an outer pushing rod hydraulic cylinder 50 coupled to each of the wing frames 28 and the respective pushing rod 48. The outer pushing rods are a second element.

In the operating position, the pushing rods 42,48 are arranged in front of the frames 26, 28, 30 and above the intake and mowing devices 12 in order to push plants in the field downward such that they can be taken hold of by the intake and mowing devices. In the transport position, the inner pushing rods 42 are pivoted forward and the outer pushing rods 48 are pivoted backward in order to make it possible to pivot the wing frames 28 upward.

During transport, the pivot frame 22 also must be locked on the support frame 18 so as to prevent an undesirable pivoting movement of the harvesting apparatus 10. Double-action pivot locking hydraulic cylinders 52 are provided on either side of the pivot frame 22 for this purpose. These pivot locking hydraulic cylinders lock the pivot frame 22 on support frame 18 when a first pressure chamber of the pivot locking hydraulic cylinder 52 is charged with hydraulic fluid and allow the pivot frame 22 to pivot freely when its second pressured chamber is charged with hydraulic fluid. This locking assembly is a fourth element.

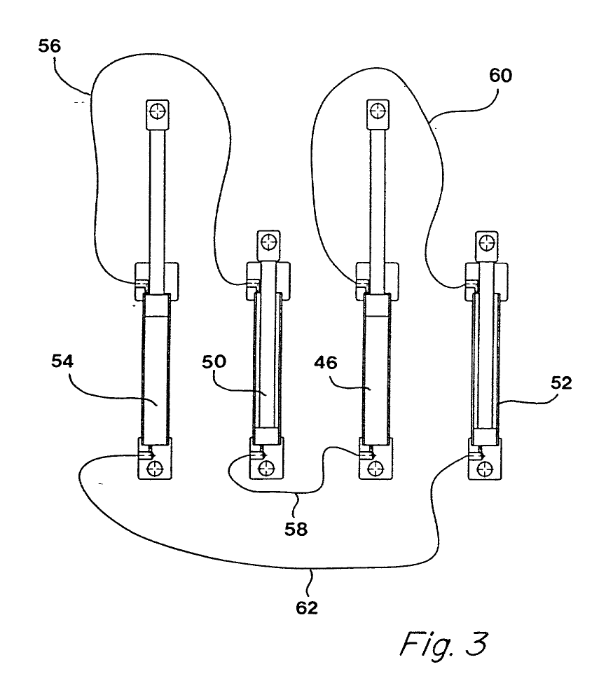

The outer wing sensing hydraulic cylinder 54, referred to as the first hydraulic cylinder below, is connected between the outer frame 30 and the central frame 28 and is mechanically extended or retracted by the outer wing pivot drive 38 during the pivoting of the outer wing frame 30. FIG. 3 shows that the first hydraulic cylinder 54 is used to drive the outer pushing rod pivot hydraulic cylinder 50, referred to as the second hydraulic cylinder below, which in turn, is used to pivot the outer pushing rod 48, as well as to drive the inner pushing rod pivot hydraulic cylinder 46 referred to as the third hydraulic cylinder below, which, in turn, is used to pivot the inner pushing rod 42 and to drive the pivot locking hydraulic cylinder 52, referred to as the fourth hydraulic cylinder below, which is used to lock the pivot bearing arrangement 14. All of the aforementioned hydraulic cylinders 46, 50, 52 and 54 are realized in the form of double-acting cylinders. It should be noted that the hydraulic cylinders 46, 50, 52 and 54 which are shown in FIG. 3 are assigned to one half of the harvesting apparatus 10 which lies on one side of the vertical central plane M. Identical hydraulic cylinders are assigned to the other side of the harvesting apparatus 10.

The piston rod pressure chamber of the first hydraulic cylinder 54 is connected to the piston rod pressure chamber of the second hydraulic cylinder 50 via a line 56. The piston pressure chamber of the second hydraulic cylinder 50 is connected to the piston pressure chamber of the third hydraulic cylinder 46 via a line 58. The piston rod pressure chamber of the third hydraulic cylinder 46 is connected to the piston rod pressure chamber of the fourth hydraulic cylinder 52 via a line 60. In addition, the piston pressure chamber of the fourth hydraulic cylinder 52 is connected to the piston pressure chamber of the first hydraulic cylinder 54 by line 62. Piston rod pressure chambers must always be connected to piston rod pressure chambers, and piston pressure chambers must always be connected to piston pressure chambers, so that identical quantities of hydraulic fluid result in the same stroke. The first hydraulic cylinder of the chain is thus again filled with a quantity of hydraulic fluid that corresponds to its stroke.

FIG. 3 shows the hydraulic cylinders in the transport position. The first hydraulic cylinder 54 is extended because it is moved into the extended position by the outer wing pivot drive 38 for pivoting the outer frame 30. The second hydraulic cylinder 50 is retracted, the third hydraulic cylinder 46 is extended, and the fourth hydraulic cylinder 52 is retracted. The elements of the harvesting apparatus 10 which are actuated by the hydraulic cylinders, namely the second element, the outer pushing rods 48; the third element, the inner pushing rods 42; and the lock of the pivot bearing arrangement 14, are in the transport position. Each given pressure chamber of the hydraulic cylinders 46, 50, 52 or 54 which is filled with hydraulic fluid is connected to an empty pressure chamber of another hydraulic cylinder.

When the outer frame 30 is pivoted, hydraulic fluid is pumped, back and forth through the hydraulic system according to the invention, between the pressure chambers of the individual hydraulic cylinders 46, 50, 52, 54.

The hydraulic system shown in FIG. 3 functions in such a way that the first hydraulic cylinder 54 is retracted when the outer frame 30 is pivoted into its operating position by the outer wing pivot drive 38. This causes the piston pressure chamber of the first hydraulic cylinder 54 to become smaller, and the piston pressure chamber of the fourth hydraulic cylinder 52 to become charged with pressurized fluid via the line 62. The fourth hydraulic cylinder 52 is now extended and the lock of the pivot bearing arrangement 14 is released. The piston rod pressure chamber of the fourth hydraulic cylinder 52 is simultaneously reduced, and the piston rod pressure chamber of the third hydraulic cylinder 46 is charged with hydraulic pressure via the line 60 such that the third hydraulic cylinder retracts and the inner pushing rod 42 is pivoted into the operating position. During the retraction of the third hydraulic cylinder 46, its piston pressure chambers becomes smaller such that hydraulic fluid flows through the line 58 and charges the piston pressure chamber of the second hydraulic cylinder 50 with pressure. This causes the second hydraulic cylinder 50 to extend so that the outer pushing rod 48 pivots into the operating position. The hydraulic fluid pressed out of the piston rod pressure chamber of the second hydraulic cylinder 50 flows into the piston surface pressure chamber of the first hydraulic cylinder 54 via the line 56.

When the elements of the harvesting apparatus are pivoted from the operating position into the transport position, the function of the hydraulic cylinders 46, 50, 52, 54 is reversed relative to the process described above. In this case, the first hydraulic cylinder 54 is extended by the upwardly pivoting outer frame so that the second hydraulic cylinder 50 retracts and the outer pushing rod 48 is pivoted backward into the transport position. During this process, the third hydraulic cylinder 46 is charged with pressure via the line 58, which causes the third hydraulic cylinder to extend so that the inner pushing rod 42 is pivoted forward into the transport position. In addition, the fourth hydraulic cylinder 52 is retracted so that the pivot bearing arrangement 14 is locked. The hydraulic fluid pressed out of the fourth hydraulic cylinder 52 flows into the piston pressure chamber of the first hydraulic cylinder 54.

The control of the wing pivot hydraulic cylinder 34 and the outer wing pivot drive 38 is preferably realized such that the outer wing pivot drive 38 is initially actuated when the harvesting apparatus is in the operating position. The hydraulic system shown in FIG. 3 moves the inner and outer pushing rods 42, 48 into the transport position, and the pivot bearing arrangement 14 is locked by the fourth hydraulic cylinder 52. Once this sequence of movements is completed, the wing pivot hydraulic cylinder 34 is actuated in order to pivot the wing frame 28. The transition from the transport position into the operating position takes place in the reverse sequence.

Having described the preferred embodiment, it will become apparent that various modifications can be made without departing from the scope of the invention as defined in the accompanying claims.

1. An agricultural harvesting apparatus having a first element that can be moved from a first element operating position into a first element transport position and moved from the first element transport position into the first element operating position by a first element drive, a second element is moved from a second element operating position into a second element transport position and moved from the second element transport position into the second element operating position by a second element hydraulic cylinder the second element hydraulic cylinder is extended and retracted by a first element hydraulic cylinder that is extended and retracted by moving of the first element.

2. An agricultural harvesting apparatus as defined by claim 1 wherein the second element hydraulic cylinder and the first element hydraulic cylinder are double acting hydraulic cylinders.

3. An agricultural harvesting machine as defined by claim 2 wherein a third element can be moved from a third element operating position into a third element transport position and moved from the third element transport position into the third element operating position by a third element hydraulic cylinder wherein the third element cylinder is hydraulically coupled to the first element hydraulic cylinder.

4. An agricultural harvesting machine as defined by claim 3 wherein a fourth element can be moved from a fourth element operating position into a fourth element transport position and moved from the fourth element transport position into the fourth element operating position by a fourth element hydraulic cylinder wherein the fourth element cylinder is hydraulically coupled to the first hydraulic cylinder.

5. An agricultural harvesting machine as defined by claim 4 wherein the first element hydraulic cylinder, the second element hydraulic cylinder, the third element hydraulic cylinder and the fourth element hydraulic cylinder form a closed hydraulic circuit.

6. An agricultural harvesting machine as defined by claim 5 wherein the first element hydraulic cylinder, the second element hydraulic cylinder, the third element hydraulic cylinder and the fourth element hydraulic cylinder are each provided with a piston rod chamber and a piston pressure chamber, wherein each piston rod pressure chamber is only hydraulically coupled to one of the other piston rod pressure chambers by a hydraulic line and each piston pressure chamber is hydraulically coupled to one of thew other piston pressure chambers by a hydraulic line.

7. An agricultural harvesting machine as defined by claim 6 wherein the first element is an outer wing frame that is pivotally mounted to a wing frame which in turn is pivotally mounted to a base frame, the outer wing frame being provided with intake and mowing devices.

8. An agricultural harvesting machine as defined by claim 7 wherein the second element is an outer pushing rod.

9. An agricultural harvesting machine as defined by claim 8 wherein the third element is an inner pushing rod.

10. An agricultural harvesting machine as defined by claim 9 wherein the base frame is pivotally attached to a carrier frame by a pivot bearing and the fourth element locks pivot bearing.

11. An agricultural harvesting apparatus having a base frame and an outer wing frame, the outer wing frame having an outer wing frame operating position and an outer wing frame transport position, the outer wing frame can be folded from the outer wing frame operating position to the outer wing frame transport position and unfolded from the outer wing frame transport position into the outer wing frame operating position by a outer wing frame pivot drive, an inner pushing rod having an inner pushing rod operating position and an inner pushing rod transport position, an inner pushing rod hydraulic cylinder is associated with the inner pushing rod for moving the inner pushing rod back and forth between the inner pushing rod transport position and the inner pushing rod operating position, an outer wing frame sensing hydraulic cylinder is associated with the outer wing frame and drives the inner pushing rod hydraulic cylinder in response to the movement of the outer wing frame by the outer wing frame pivot drive.

12. An agricultural harvesting apparatus as defined by claim 11 wherein the inner pushing rod is pivotally mounted to the base frame.

13. An agricultural harvesting apparatus having a wing frame and an outer wing frame, the outer wing frame having an outer wing frame operating position and an outer wing frame transport position, the outer wing frame can be folded from the outer wing frame operating position to the outer wing frame transport position and unfolded from the outer wing frame transport position into the outer wing frame operating position by a outer wing frame pivot drive, an outer pushing rod having an outer pushing rod operating position and an outer pushing rod transport position, an outer pushing rod hydraulic cylinder is associated with the outer pushing rod for moving the outer pushing rod back and forth between the outer pushing rod transport position and the outer pushing rod operating position, an outer wing frame sensing hydraulic cylinder is associated with the outer wing frame and drives the outer pushing rod hydraulic cylinder in response to the movement of the outer wing frame by the outer wing frame pivot drive.

14. An agricultural harvesting apparatus as defined by claim 13 wherein the outer pushing rod is pivotally mounted to the wing frame.

15. An agricultural harvesting apparatus having a base frame and an outer wing frame, the base frame being pivotally coupled to a carrier frame by a pivot bearing, the outer wing frame having an outer wing frame operating position and an outer wing frame transport position, the outer wing frame can be folded from the outer wing frame operating position to the outer wing frame transport position and unfolded from the outer wing frame transport position into the outer wing frame operating position by a outer wing frame pivot drive, a pivot bearing locking assembly having a locking operating position and a locking transport position, a locking hydraulic cylinder is associated with the pivot bearing locking assembly for locking the pivot bearing assembly when the outer wing frame is positioned in the outer wing frame transport position and pivot bearing locking assembly is unlocked when the outer wing frame is positioned in the outer wing frame operating position, the pivot bearing locking assembly being provided with a pivot locking hydraulic cylinder which is hydraulically coupled to an outer wing frame sensing hydraulic cylinder, the outer wing frame sensing hydraulic cylinder is associated with the outer wing frame and drives the pivot locking hydraulic cylinder in response to the movement of the outer wing frame by the outer wing frame pivot drive.
